(19) United States
(12) Patent Application Publication
(10) Pub. No.: US 2023/0276392 A1
(43) Pub. Date: Aug. 31, 2023

(54) SERVICE ACCESS TO DISJOINT NETWORK SLICES

(71) Applicant: NEC Corporation, Minato-ku, Tokyo (JP)

(72) Inventors: Iskren IANEV, Tokyo (JP); Toshiyuki Tamura, Tokyo (JP); Kundan Tiwari, Tokyo (JP)

(73) Assignee: NEC Corporation, Minato-ku, Tokyo (JP)

(21) Appl. No.: 18/017,294

(22) PCT Filed: Dec. 27, 2021
(86) PCT No.: PCT/JP2021/048654

§ 371 Date: Jan. 20, 2023

(30) Foreign Application Priority Data
Dec. 30, 2020 (IN) 202011057170

(51) Int. Cl. H04W 60/00; H04W 76/10; H04W 48/18

(52) U.S. Cl. CPC H04W 60/00; H04W 76/10; H04W 48/18

(57) ABSTRACT

The disclosure is addressing the service access to disjoint network slices. It proposes solutions for on demand registration to a disjoint network slice(s) and a switch between disjoint network slices with minimum interruption. This allows for isolation between the network slices leading to improved 5G security and integrity in the data exchange.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof. The disclosure has particular although not exclusive relevance to on demand registration to disjoint network slices in the so-called ‘5G’ (or ‘Next Generation’) systems.

### BACKGROUND ART

Network slicing features defined in 3GPP release 15 and release 16 enable a great variety of communication services for operators and verticals alike. To enhance the commercial viability of Network Slicing, GSMA SGJA has introduced in document NG.116 the concept of Generic Slice Template (GST) [6] from which several Network Slice Types descriptions can be derived. Some of the parameters in the GST point explicitly to the definition of parameters and bounds on the service delivered to the end customer. However, the enforcement of some of these parameters and bounds are not supported by the 5GS yet.

3GPP SA1 study on Enhanced Access to and Support of Network Slices for Rel-18 [4] is looking at various use cases and scenarios using network slices, in order to identify potential service requirements for the 5G system, e.g.:
when there is a restriction of network slice to e.g., certain frequency bands/sub bands, Radio Access Technologies (RATs), geographical areas, networks and applications,
when a UE has a subscription to multiple network slices and these network slices are deployed for e.g., different frequency bands/sub bands, RATs, geographical area and applications,
when there is a preference or prioritization for a network slice over other network slices e.g. when there are conflicting constraints on network slice availability.

### CITATION LIST

### Non Patent Literature

NPL 1: 3GPP TR 21.905: “Vocabulary for 3GPP Specifications” V16.0.0 (2019-06)—https://www.3gpp.org/ftp//Specs/archive/21 series/21.905/21905-g00.zip
NPL 2: 3GPP TS 23.501: “System Architecture for the 5G System (5GS)” V16.7.0 (2020-12)—http://www.3gpp.org/ftp/Specs/archive/23 series/23.501/23501-g70.zip NPL 3: 3GPP TS 23.502: “Procedures for the 5G System (5GS)” V16.7.0 (2020-12)—http://www.3gpp.org/ftp/Specs/archive/23 series/23.502/23502-g70.zip
NPL 4: 3GPP TR 22.835: “Study on Enhanced Access to and Support of Network Slices” V0.2.0 (2020-11)—http://www.3gpp.org/ftp/Specs/archive/22 series/22.835/22835-020.zip
NPL 5: 3GPP TR 23.700-40: “Study on Enhancement of Network Slicing Phase 2” V1.2.0 (2020-11)—http://www.3gpp.org/ftp/tsg_sa/WG2_Arch/Latest SA2_Specs/Latest_draft_S2_S pecs/23700-40-120.zip
NPL 6: GSM Association Official Document NG.116: “Generic Network Slice Template” V2.0 (2019-10)—https://www.gsma.com/newsroom/wp-content/uploads/NG.116-v2.0.pdf
NPL 7: 3GPP TS 38.413: “NG-RAN; NG Application Protocol (NGAP)” V16.3.0 (2020-09)—https://www.3gpp.org/ftp//Specs/archive/38_series/38.413/38413-g30.zip

### SUMMARY OF INVENTION

### Technical Problem

As more network slices are deployed, it is likely that each UE is subscribed to multiple network slices. While some network slice services can be simultaneously provided to the UE, there can be network slices which cannot simultaneously provide services to the UE. This is because there are multiple related factors for a network slice, e.g., enterprise use vs personal use, isolation requirement, general public use vs public safety use, frequency limitation, location restriction, etc.

FIG. 1 illustrates schematically an example of disjoint network slices. Specifically, FIG. 1 illustrates the use case scenario where a (R)AN node connects to Slice M provided via a Core Network node for access and mobility management (e.g., AMF Y) and to the Slice N provided by another Core Network node for access and mobility management (e.g., AMF X) of the same PLMN. For example, Slice M is used for public security and Slice N is used for Internet access. In the Core Network (e.g., 5GC), the dedicated network resources and the network functionalities are separately customised for public security emergency service and video service to meet the isolation requirements, which ensures the independence of core network resources between different network slices.

Accordingly, the two network slices are isolated and cannot be simultaneously provided to the UE. Such network slices are called disjoint network slices.

### Subscription and Configuration:

UE A1 and A3 have a subscription to Slice M.
UE A2 and A3 have a subscription to Slice N.
For UE A3, it is configured which applications use which network slices.

### Deployment:

Slice N and Slice M are isolated.
(R)AN is able to connect to both Slice M and Slice N.
Slice M and Slice N are provided by the same PLMN.
   Problem statement: There is no mechanism in the Telecommunication system (e.g., 5GS) to prevent from accessing to multiple network slices simultaneously for those of UEs subscribing to multiple network slices which shall not be provided to the UE simultaneously (e.g. disjoint network slices).

To meet this requirement, the Telecommunication system (e.g., 5G system) shall be able to:
provide the UE with the most suitable network slice (e.g. based on the ongoing applications, user preference);
support change of provided network slices with minimized interruption (e.g. when triggered by change of active applications, priorities).

### Solution to Problem

A communication terminal (3) according to one aspect includes:
means for sending, to a core network node (10A), a first Non-Access Stratum, NAS, message including first information and second information, the first information indicating that the communication terminal (3) supports on demand registration feature, the second information indicating a list of network slices which the communication terminal (3) requests registration for;
means for receiving, from the core network node (10A), a second NAS message including third information and fourth information, the third information indicating a first network slice which the communication terminal (3) uses in a Public land mobile network, PLMN, the fourth information indicating a second network slice for which the communication terminal (3) is subscribed and which is supported by the PLMN but is not supported by the core network node (10A) that the communication terminal (3) is registered with, the first network slice and the second network slice being included in the list; and
means for triggering on demand registration for the second network slice.

A core network node (10A) according to one aspect includes:
means for receiving, from a communication terminal (3), a first Non-Access Stratum, NAS, message including first information and second information, the first information indicating that the communication terminal (3) supports on demand registration feature, the second information indicating a list of network slices which the communication terminal (3) requests registration for;
means for generating fourth information in a case where the first NAS message is received, the fourth information indicating a second network slice for which the communication terminal (3) is subscribed and which is supported by a Public land mobile network, PLMN, but is not supported by the core network node (10A) that the communication terminal (3) is registered with; and
means for sending, to the communication terminal (3), a second NAS message including third information and the fourth information, the third information indicating a first network slice which the communication terminal (3) uses in the PLMN, the first network slice and the second network slice being included in the list.

A method for a communication terminal (3), the method to one aspect includes: sending, to a core network node (10A), a first Non-Access Stratum, NAS, message including first information and second information, the first information indicating that the communication terminal (3) supports on demand registration feature, the second information indicating a list of network slices which the communication terminal (3) requests registration for;
receiving, from the core network node (10A), a second NAS message including third information and fourth information, the third information indicating a first network slice which the communication terminal (3) uses in a Public land mobile network, PLMN, the fourth information indicating a second network slice for which the communication terminal (3) is subscribed and which is supported by the PLMN but is not supported by the core network node (10A) that the communication terminal (3) is registered with, the first network slice and the second network slice being included in the list; and
triggering on demand registration for the second network slice.

A method for a core network node (10A), the method to one aspect includes:
receiving, from a communication terminal (3), a first Non-Access Stratum, NAS, message including first information and second information, the first information indicating that the communication terminal (3) supports on demand registration feature, the second information indicating a list of network slices which the communication terminal (3) requests registration for;
generating fourth information in a case where the first NAS message is received, the fourth information indicating a second network slice for which the communication terminal (3) is subscribed and which is supported by a Public land mobile network, PLMN, but is not supported by the core network node (10A) that the communication terminal (3) is registered with; and
sending, to the communication terminal (3), a second NAS message including third information and the fourth information, the third information indicating a first network slice which the communication terminal (3) uses in the PLMN, the first network slice and the second network slice being included in the list.

### Advantageous Effects of Invention

The present disclosure proposes on demand registration to network slices the UE is not registered to. This allows for the UE to access service on disjoint network slices via on demand registration when access to disjoint network slices is required by the UE or by an application on the UE. It allows maintaining the isolation between the disjoint network slices leading to improved 5G security and integrity in the data exchange.

### BRIEF DESCRIPTION OF DRAWINGS

FIG. 1 illustrates schematically an example of disjoint network slices.

FIG. 2 is a schematic timing (signalling) diagram illustrating an exemplary method for UE initial registration.

FIG. 3 illustrates solution 1 proposes ‘on demand registration’ to disjoint network slice(s) (e.g. a disjoint network slice S-NSSAI_N).

FIG. 4 illustrates solution 2 proposes ‘on demand registration’ for disjoint network slice(s) via re-routing to the AMF 10 that supports the in demand S-NSSAI(s) (e.g. disjoint network slices).

FIG. 5 schematically illustrates a mobile (cellular or wireless) telecommunication system 1 to which the above aspects are applicable.

FIG. 6 is a block diagram illustrating the main components of a UE (mobile device 3) shown in FIG. 5.

FIG. 7 is a block diagram illustrating the main components of an exemplary (R)AN node 5 (base station) shown in FIG. 5.

FIG. 8 is a block diagram illustrating the main components of a generic core network node (or function) shown in FIG. 5, for example, the AMF 10, the PCF 13, the UDM/UDR 15, and the NSSF 17.

### DESCRIPTION OF EMBODIMENTS

### Abbreviations

3GPP 3rd Generation Partnership Project
5G 5th Generation
5GC 5G Core Network
5GS 5G System
5G-AN 5G Access Network
AF Application Function
AMF Access and Mobility Management Function
AS Application Server
AUSF Authentication Server Function
CAG Closed Access Group
CST Generic Network Slice Template
GSMA Global System for Mobile Communications
GUAMI Globally Unique AMF Identifier
gNB Next generation Node B
GST Generic Slice Template
MM Mobility Management
MNO Mobile Network Operator
NAS Non-Access Stratum
NF Network Function
NG-RAN Next Generation Radio Access Network
NID Network identifier
NPN Non-Public Network
NR New Radio
NSSAI Network Slice Selection Assistance Information
NSSF Network Slice Selection Function
PCC Policy and Charging Control
PCF Policy Control Function
PDU Protocol Data Unit
PLMN Public land mobile network
PNI-NPN Public Network Integrated NPN
(R)AN (Radio) Access Network
RAT Radio Access Technology
RRC Radio Resource Control
SAE System Architecture Evolution
SNPN Stand-alone Non-Public Network
S-NSSAI Single Network Slice Selection Assistance Information
S-TMSI SAE-Temporary Mobile Subscriber Identity
UDM Unified Data Management
UDR Unified Data Repository
UE User Equipment
URSP UE Route Selection Policy

### Definitions

For the purposes of the present document, the terms and definitions given in 3GPP Technical Report (TR) 21.905 (NPL 1) and the following apply. A term defined in the present document takes precedence over the definition of the same term, if any, in 3GPP TR 21.905 (NPL 1).

Common Aspect
Applicability of aspect

All disclosures in the present aspect are applicable not only to the network slice handling within the PLMN but also are applicable to the network slice switching between one network slice in the PLMN and another network slice in the Non-Public Network (NPN). In addition, all disclosures in the present aspect are applicable to the network slice handling within the NPN. The NPN can be either Stand-alone Non-Public Network (SNPN) or Public Network Integrated NPN (PNI-NPN).
New definitions

The following new definitions are proposed:
Available NSSAI (or any other notation for network slices conforming to the following definition)—a list of one or more network slices (e.g. S-NSSAI(s)) for which the UE 3 is subscribed and which are supported by the PLMN however, they are not supported by the current AMF 10 that the UE 3 is registered with. The members of the ‘Available NSSAI’ are called available network slices (e.g. available S-NSSAI(s)). The list of the available network slices may be generated by a network node (e.g. the AMF 10) based on the interaction with other network node(s) (e.g. the (R)AN node 5 and/or the Network Slice Selection Function node (e.g. NSSF 17) and/or Policy Control Function node (e.g. PCF 13) and/or Server for storing subscription information (e.g. UDM/UDR 15) and/or operator policy and/or configuration in order to identify the network slices for which the UE 3 did not or could not register but are supported by the PLMN and the UE 3 has a subscription for. The list of available network slices may be provided to the UE 3 during the registration procedure within the ‘Available NSSAI’ parameter (e.g. within the Registration Accept message) or via the UE Configuration Update procedure within the UE policy parameter (e.g. as part of the UE Route Selection Policy (URSP) parameter) or as an independent parameter. In one example the available network slices list can be provided in an existing NAS message or in a new NAS message during a NAS procedure (e.g. Service request procedure) in addition to the registration procedure or the UE configuration update procedure. It can also be provided using an existing Access Stratum message (e.g. RRC SETUP message or RRC Reconfiguration Request message or RRC Release message). The available NSSAI may exist per access type, e.g. one available NSSAI for 3GPP Access and another available NSSAI for non-3GPP access. In one example, the available NSSAI can be provided per PLMN or per Registration Area where the UE 3 has been registered during the registration procedure.

In case that the UE 3 needs to switch network slice(s) between a network slice in the PLMN and a network slice in the PNI-NPN or to switch network slice(s) within the NPN, the term in the disclosure “network slice” may be interpreted as “Closed Access Group (CAG)” or a combination of “CAG” and “network slice” or “Network identifier (NID)”.

The available NSSAI may take a different definition. Possible different definitions may be listed below:

One or more network slices (e.g. S-NSSAI(s)) that are supported by the PLMN and also listed in the Subscribed NSSAI of the UE 3.

One or more network slices (e.g. S-NSSAI(s)) that are supported by the Registration Area in the PLMN and are also listed in the Subscribed NSSAI of the UE 3.

One or more network slices (e.g. S-NSSAI(s)) that are supported by the PLMN and are also listed in the Configured NSSAI of the UE 3.

One or more network slices (e.g. S-NSSAI(s)) that are supported by the Registration Area in the PLMN and are also listed in the Configured NSSAI of the UE 3.

One or more network slices (e.g. S-NSSAI(s)) that are supported by the PLMN and are also listed in the Subscribed NSSAI of the UE 3 minus one or more network slices listed in the allowed NSSAI.

One or more network slices (e.g. S-NSSAI(s)) that are supported by the Registration Area in the PLMN and are also listed in the Subscribed NSSAI of the UE 3 minus one or more network slices listed in the allowed NSSAI.

One or more network slices (e.g. S-NSSAI(s)) that are supported by the PLMN and are also listed in the Configured NSSAI of the UE 3 minus one or more network slices listed in the allowed NSSAI.

One or more network slices (e.g. S-NSSAI(s)) that are supported by the Registration Area in the PLMN and are also listed in the Configured NSSAI of the UE 3 minus one or more network slices listed in the allowed NSSAI.
On demand registration (or any other notation for procedure conforming to the following definition)—A registration by the UE 3 to available network slices (e.g. available S-NSSAI(s)). One example for such available network slices are the disjoint network slices for which the UE 3 could not register in the first place as they are not supported simultaneously. The UE 3 triggers on demand registration when an application on the UE 3 requires access to one or more available network slice(s) (e.g. available S-NSSAI(s)), i.e. network slices for which the UE 3 is not registered to but for which the UE 3 is subscribed to and which are supported by the PLMN.
On demand registration feature support indication (or any other notation for information conforming to the following definition)—A UE 3 that supports ‘on demand registration’ indicates ‘on demand registration feature support’ indication at registration (e.g., within the Registration Request message) so that the network provides back a list of available network slices (e.g. available S-NSSAI(s)), if any.
In demand NSSAI (or any other notation for network slices conforming to the following definition):

A list of one or more network slices (e.g. S-NSSAI(s)) for which the UE 3 triggers on demand registration, PDU session establishment request, or service request.

The members of the ‘In demand NSSAI’ parameter are called in demand network slices (e.g. in demand S-NSSAI(s)) and they are provided to the network during the registration (e.g. within the Registration Request message) or UE Configuration Update procedures.

One example for in demand network slices are the disjoint network slices for which the UE 3 could not register previously as the disjoint network slices are not supported simultaneously.

Initial registration with available network slices list provision to the UE 3

The following example with the UE initial registration is a preparation procedure for the proposed new solutions.

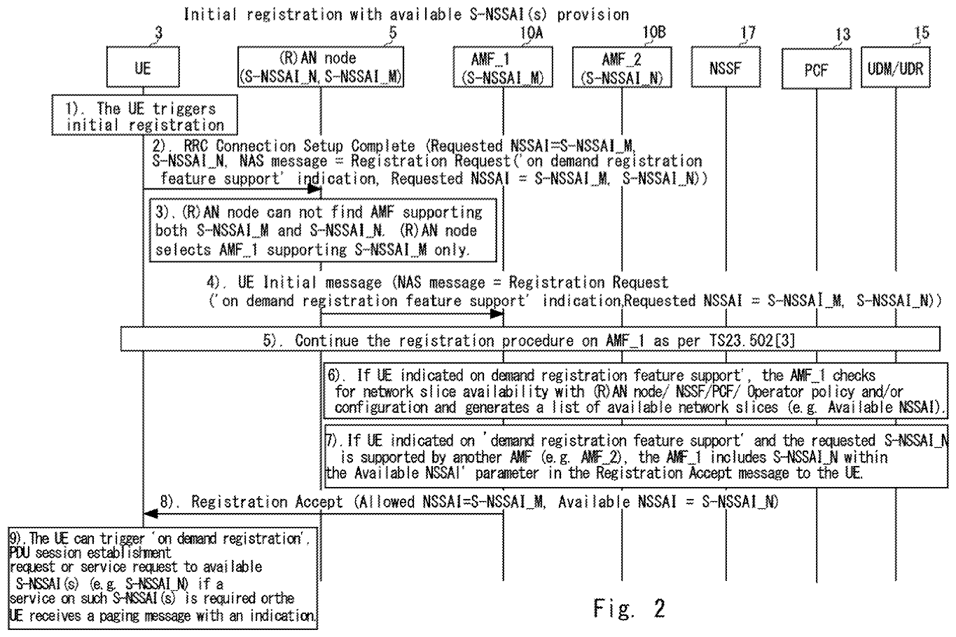

FIG. 2 is a schematic timing (signalling) diagram illustrating an exemplary method for UE initial registration. A UE 3 is subscribed for the network slices S-NSSAI_M and S-NSSAI_N and camped on a cell supporting both the network slices S-NSSAI_M and S-NSSAI_N. The UE 3 requests registration on both the network slices however, the registration is successful only for the network slice S-NSSAI_M as the two requested network slices S-NSSAI_M and S-NSSAI_N are disjoint network slices and are supported by different AMFs 10 (e.g. AMF_1 10A supports S-NSSAI_M and AMF_2 10B supports S-NSSAI_N) in the UE location. If the UE 3 indicated ‘on demand registration feature support’ in the Registration Request message, then the disjoint network slice S-NSSAI_N is returned to the UE 3 as an available network slice because although it is not supported by the current AMF_1 10A, it is supported by another AMF 10 (e.g. AMF_2 10B) in the UE location.
1). The UE 3 triggers initial registration with the network (e.g. in a case that the UE 3 is switched ON, the step is initiated).
2). The UE 3 transmits the RRC Connection Setup Complete message (Requested NSSAI=S-NSSAI_M, S-NSSAI_N, NAS message=Registration Request (‘on demand registration feature support’ indication, Requested NSSAI=S-NSSAI_M, S-NSSAI_N)) to the (R)AN node 5. The UE 3 first triggers the RRC connection establishment procedure with the (R)AN node 5 and the UE 3 includes the S-NSSAI_M and S-NSSAI_N within the Requested NSSAI parameter in the RRC Connection Setup Complete message and the UE 3 also includes the Registration Request message in the RRC Connection Setup Complete message as per TS23.502 [3]. In the Registration Request message the UE 3 includes ‘on demand registration feature support’ indication to indicate that the UE 3 supports the ‘on demand registration’ feature (e.g. registration to disjoint network slices).
3). If the (R)AN node 5 cannot find the AMF 10 supporting both the S-NSSAI_M and S-NSSAI_N, the (R)AN node 5 selects the AMF_1 10A supporting S-NSSAI_M only.
4). The (R)AN node 5 sends the UE Initial message (NAS message=Registration Request (‘on demand registration feature support’ indication, Requested NSSAI=S-NSSAI_M, S-NSSAI_N)) to the selected AMF_1 10A. The (R)AN node 5 forwards the Registration Request message from the UE 3 to the selected AMF_1 10A.
5). Continue the registration procedure with the AMF_1 10A as per 3GPP Technical Specification (TS) 23.502 [3].
6). If the UE 3 indicated ‘on demand registration feature support’, the AMF_1 10A checks for network slice availability with the (R)AN node 5/NSSF 17/PCF 13/UDM/UDR 15/Operator policy or configuration and the AMF_1 10A generates a list of available network slices (e.g. Available NSSAI).

The AMF_1 10A may retrieve the list of UE subscribed network slices from the UDM/UDR 15 and the AMF_1 10A may check with the NSSF 17 which of these UE subscribed network slices are not supported by the PLMN and the UE 3 may also check with the PCF 13 for any network slice access restrictions based on different criteria by the PCC rules in the PCF 13 (e.g. network slices access restriction based on location or time or a restriction per specific UE 3 or access restriction based on any other criteria). The UDM/UDR 15 may provide an additional network slice information per subscribed network slice basis about network slices that are disjoint with a subscribed network slice.

The (R)AN node 5 may also provide information to the AMF_1 10A to generate a list of available network slices (e.g. Available NSSAI). For example, the AMF_1 10A may obtain, from the (R)AN node 5, information regarding S-NSSAI(s) which are supported by respective neighboring AMFs 10. Each (R)AN node 5 connected to the AMF_1 10A may provide a combination of the S-NSSAI and the associated AMF 10 in the NG SETUP REQUEST message, RAN CONFIGURATION UPDATE ACKNOWLEDGE message or AMF CONFIGURATION UPDATE message as defined in the 3GPP TS 38.413 [7] or any other name of message(s) between the (R)AN node 5 and AMF 10.

The AMF_1 10A may also consider any other network slice access restrictions based on the operator policy or configurations.

Based on these interactions with the UDM/UDR 15, NSSF 17, PCF 13, (R)AN node 5 and/or operator policy and/or configuration, the AMF_1 10A generates a list of network slices (e.g. Available NSSAI) called list of available network slices. So, the available network slices are the network slices that are:
supported in the PLMN or in the Registration Area within the PLMN;
with valid UE subscription;
not provided to the UE 3 as an allowed network slices at this registration procedure.

This list of available network slices (e.g. Available NSSAI) may include disjoint network slices that the UE 3 has requested to register for however, the registration was not granted as they were disjoint network slices and although they are supported within the PLMN or within the Registration area, they are not supported by the AMF 10 the UE 3 registers with (e.g. AMF_1 10A).

The list of available network slices (e.g. Available NSSAI) may also include network slices the UE 3 has not requested registration for but for which the UE 3 has a valid subscription.

The list of available network slices (e.g. Available NSSAI) may also include some network slices that are included in the list of rejected network slices, depending on the reject cause (e.g. network slices that are rejected because they are not supported by the current AMF 10 however, they are supported by other AMFs 10 in the PLMN, i.e. disjoint network slices).
7). If the UE 3 indicated ‘on demand registration feature support’ in the Registration Request message and the requested S-NSSAI_N is supported by another AMF 10 (e.g. AMF_2 10B), the AMF_1 10A includes the S-NSSAI_N within the list of available network slices, e.g. in the ‘Available NSSAI’ parameter in the Registration Accept message to the UE 3.
8). The AMF_1 10A sends the Registration Accept message (Allowed NSSAI=S-NSSAI_M, Available NSSAI=S-NSSAI_N) to the UE 3.

The AMF_1 10A confirms the registration for the NSSAI_M by including the NSSAI_M in the Allowed NSSAI parameter and the AMF_1 10A also returns the S-NSSAI_N (which now is an available S-NSSAI) within the Available NSSAI parameter. Alternatively, the available S-NSSAI_N may be provided to the UE 3 with an extra differentiated tag (e.g., information, indication, or parameter) within an already existing parameter like the Allowed NSSAI or Rejected NSSAI or any other existing parameter within the Registration Accept message so that the UE 3 can distinguish the S-NSSAI_N from the other network slices.
9). The UE 3 is successfully registered for S-NSSAI_M and the UE 3 also received S-NSSAI_N as an available S-NSSAI. The UE 3 can trigger ‘on demand registration’, PDU session establishment request, or service request to the available S-NSSAI(s) (e.g. the disjoint S-NSSAI_N) if service(s) on such S-NSSAI(s) is required by the UE or by the application(s) on the UE 3 or the UE 3 receives a Paging message with an indication that the UE 3 requires to activate service(s) on such S-NSSAI(s).

Alternatively, the UE 3 can also, independently from the network, predict, determine, or generate which network slices qualify as available S-NSSAI(s) by deducting the allowed S-NSSAI(s) from the subscribed S-NSSAI(s) list however, in this case there is higher chance the ‘on demand registration’, PDU session establishment request or service request to be rejected as without the network assistance the UE would not have the full information regarding the network slices availability.

In one example, for those of UEs 3 that do not support ‘on demand registration feature’, the AMF_1 10A may set the S-NSSAI_N to the allowed NSSAI in the Registration Accept message although the AMF_1 10A does not support S-NSSAI_N. This may happen in case that the UE 3 does not include ‘on demand registration feature support’ indication in the Registration Request message and the AMF_1 10A is aware that the UE 3 can access to the S-NSSAI_N with other AMF 10 while the UE 3 stays in the Registration Area. After this Registration procedure, if the AMF_1 10A receives a PDU Session Establishment Request message or the Service Request message from the UE 3 with the S-NSSAI_N, the AMF_1 10A sends a PDU Session Establishment Reject message or a Service Reject message to the UE 3 with a new cause value or existing cause value indicating to the UE 3 that re-registration is required. When the AMF_1 10A receives a new Registration Request message from the UE 3 with the S-NSSAI_N set in the Requested NSSAI, the AMF_1 10A treats the S-NSSAI_N as an in demand NSSAI parameter as described in the Solution 2 so that the AMF_1 10A can reroute the Registration Request message to a neighbouring AMF 10 (e.g. AMF_2 10B) that supports S-NSSAI_N as described in the Solution 2.

Solution 1—Disjoint Network Slice Access Via on Demand Registration

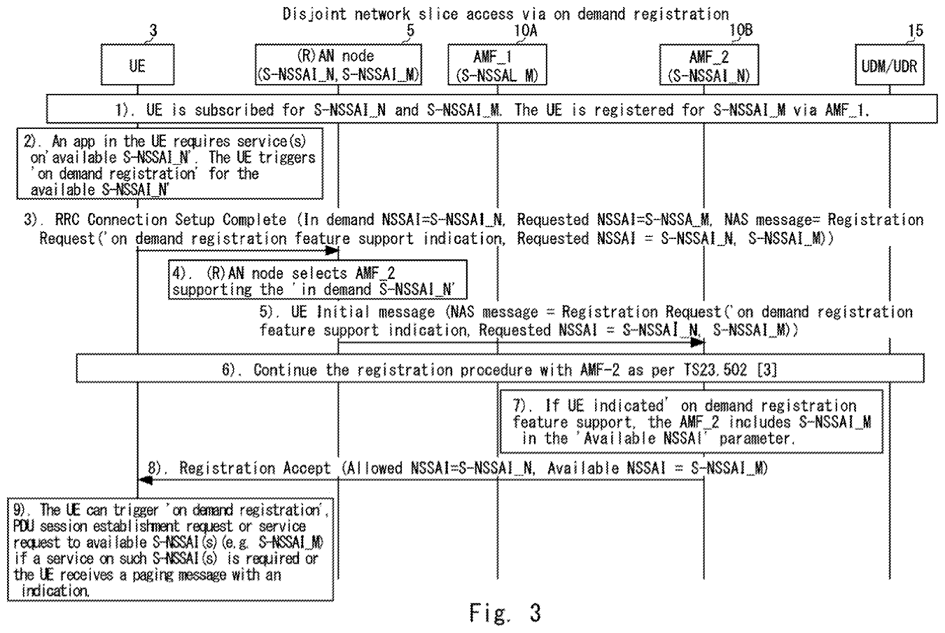

Solution 1 proposes ‘on demand registration’ to disjoint network slice(s) (e.g. a disjoint network slice S-NSSAI_N), as illustrated in FIG. 3. When an application (App) in the UE 3 requires service(s) on disjoint or available S-NSSAI(s), e.g. S-NSSAI_N, the UE 3 triggers on demand registration by placing the required ‘available S-NSSAI_N’ in the RRC message and in the Registration Request message. The UE 3 also indicates its support for the ‘on demand registration feature’.

1). A UE 3 is subscribed for the S-NSSAI_N and S-NSSAI_M. The UE 3 is in idle mode, camped on a cell that supports both the S-NSSAI_N and S-NSSAI_M and the UE 3 is registered for the S-NSSAI_M via the AMF_1 10A. During the UE registration for the S-NSSAI_M with the AMF_1 10A, the UE 3 has been allocated an available S-NSSAI_N as the S-NSSAI_N was disjoint with the S-NSSAI_M (e.g. as shown in FIG. 2 and related description).

During the registration procedure, the UE 3 may obtain information regarding a support of ‘on demand registration feature’ from the (R)AN node 5, based on information that is conveyed in the RRC release or any RRC message during the registration procedure. Alternatively, the UE 3 may obtain the information regarding a support of ‘on demand registration feature’ from the (R)AN node 5, via a system information on a broadcasting channel.
2). An app in the UE 3 requires service(s) on a disjoint network slice, e.g. the ‘available S-NSSAI_N’. The network slice S-NSSAI_N is available in the PLMN (e.g. supported by the PLMN) however, the UE 3 is not registered for it. The UE 3 triggers ‘on demand registration’ for a disjoint network slice, e.g. available S-NSSAI_N.
3). The UE 3 transmits the RRC Connection Setup Complete message (In demand NSSAI=S-NSSAI_N, Requested NSSAI=S-NSSAI_M, NAS message=Registration Request (‘on demand registration feature support’ indication, Requested NSSAI=S-NSSAI_N, S-NSSAI_M)) to the (R)AN node 5. The UE 3 first triggers RRC connection establishment procedure with the (R)AN node 5 and the UE 3 includes the disjoint available S-NSSAI_N in the ‘In demand NSSAI’ parameter, and the requested S-NSSAI_M in the Requested NSSAI parameter, and the Registration Request message as the NAS message in the RRC Connection Setup Complete message. The UE 3 includes the ‘in demand S-NSSAI_N’ and the requested S NSSAI_M in the RRC Connection Setup Complete message and the UE 3 may not include the GUAMI or 5G-S-TMSI or 5G-GUTI in the RRC Connection Setup Complete message in order to force the (R)AN node 5 to perform AMF selection although the UE 3 has not changed its location (e.g. the UE 3 stays in the same cell). The ‘in demand S-NSSAI_N’ has a preference/priority over the requested S-NSSAI_M in case the (R)AN node 5 cannot find an AMF 10 supporting both the network slices S-NSSAI_N and S-NSSAI_M. The UE 3 may not include the requested S_NSSAI_M in the RRC Connection Setup Complete message.

Alternatively, the in demand S-NSSAI_N may be provided to the (R)AN node 5 with an extra differentiated tag (e.g., information, indication, or parameter) within an already existing parameter like the Requested NSSAI or any other existing parameter within the RRC message so that the (R)AN node 5 can distinguish the in demand S-NSSAI_N from the other network slices and give a preference to the in demand S-NSSAI_N when selecting an AMF 10.

In the Registration Request message the UE 3 includes ‘on demand registration feature support’ indication to indicate that the UE 3 supports the ‘on demand registration’ feature. The UE 3 also includes the S-NSSAI_N in the Requested NSSAI along with the other requested S-NSSAI(s), e.g. S-NSSAI_M.
4). The (R)AN node 5 selects the AMF_2 10B which supports the ‘in demand S-NSSAI_N’ as it is with preference over S-NSSAI_M.
5). The (R)AN node 5 sends the UE Initial message (NAS message=Registration Request (‘on demand registration feature support’ indication, Requested NSSAI=S-NSSAI_N, S-NSSAI_M)) to the AMF_2 10B. The (R)AN node 5 forwards the Registration Request message from the UE 3 to the AMF_2 10B.
6). Continue the registration procedure with the AMF_2 10B as per TS23.502
7). If the UE 3 indicated ‘on demand registration feature support’ in the Registration Request message, the AMF_2 10B includes the S-NSSAI_M in the ‘Available NSSAI’ parameter back to the UE 3 as the S-NSSAI_M is not supported by the AMF_2 10B because the S-NSSAI_M and S-NSSAI_N are disjoint network slices and are not supported by the same AMF_2 10B however, S-NSSAI_M is available in the PLMN and the UE 3 is subscribed for it. When deciding whether the S-NSSAI_M is an available S-NSSAI, the AMF_2 10B may interact with the UDM/UDR 15, PCF 13 and/or other network nodes to verify whether the S-NSSAI_M is a UE subscribed network slice and the S-NSSAI_M is not restricted by the PCC rules or by operator policy or configuration. AMF_2 10B may also check with the NSSF 17 whether the S-NSSAI_M is supported by another AMF 10 in the location of the UE 3.
8). The AMF_2 10B sends the Registration Accept message (Allowed NSSAI=S-NSSAI_N, Available NSSAI=S-NSSAI_M) to the UE 3. The AMF_2 10B confirms the registration for the disjoint network slice S-NSSAI_N, i.e. the ‘in demand S-NSSAI_N’ by including the S-NSSAI_N in the Allowed NSSAI parameter and the AMF_2 10B also returns the S-NSSAI_M (which now is an available S-NSSAI) within the Available NSSAI parameter. Alternatively, the available S-NSSAI_M may be provided to the UE 3 with an extra differentiating tag (e.g., information, indication or parameter) within an already existing parameter like the Allowed NSSAI or Rejected NSSAI or any other existing parameter within the Registration Accept message so that the UE 3 can distinguish the S-NSSAI_M from the other network slices.
9). The UE 3 can trigger ‘on demand registration’, PDU session establishment request, or service request to the disjoint available S-NSSAI(s) (e.g. S-NSSAI_M) if service(s) on such S-NSSAI(s) is required by the UE 3 or by the application(s) on the UE 3 or the UE 3 receives a Paging message with an indication that the UE 3 requires to activate service(s) on such S-NSSAI(s).

Alternatively, the UE 3 can also, independently from the network, predict, determine, or generate which network slices qualify as available S-NSSAI(s) by deducting the allowed S-NSSAI(s) from the subscribed S-NSSAI(s) list however, in this case there is higher chance the ‘on demand registration’ or service request to be rejected as without the network assistance the UE 3 would not have the full information regarding the network slices availability.

In one example, the UE 3 may set the S-NSSAI_N to the Requested NSSAI and not to set any of GUAMI or 5G-S-TMSI or 5G-GUTI in the RRC Connection Setup Complete message. Then the (R)AN node 5 performs AMF selection, based on existing mechanism, although the UE 3 has not changed its location (e.g. the UE 3 stays in the same cell).

Solution 2—Disjoint Network Slice Access Via on Demand Registration Re-Route

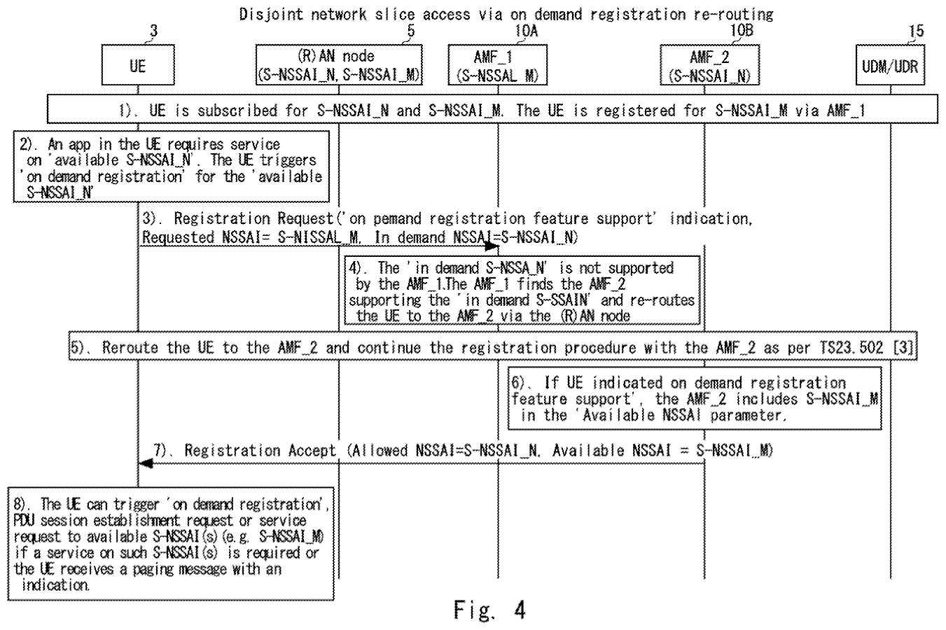

Solution 2 proposes ‘on demand registration’ for disjoint network slice(s) via re-routing to the AMF 10 that supports the in demand S-NSSAI(s) (e.g. disjoint network slices), as illustrated in FIG. 4. When an application (App) in the UE 3 requires service(s) on disjoint or available S-NSSAI(s), e.g. S-NSSAI_N, the UE 3 triggers on demand registration by placing the required available S-NSSAI_N into the ‘In demand NSSAI’ parameter in the Registration Request message to the AMF_1 10A. As the AMF_1 10A does not support the S-NSSAI_N in the demand NSSAI, the AMF_1 10A finds an AMF 10 that supports the S-NSSAI_N and forwards the Registration Request message to the found AMF 10 (e.g. AMF_2 10B). The UE 3 also indicates its support for the ‘on demand registration’ feature.
1). A UE 3 is subscribed for the S-NSSAI_N and S-NSSAI_M. The UE 3 is in idle mode, camped on a cell that supports both the S-NSSAI_N and S-NSSAI_M and the UE 3 is registered for the S-NSSAI_M via the AMF_1 10A. During the UE registration for the S-NSSAI_M with the AMF_1 10A, the UE 3 has been allocated an available S-NSSAI_N as the S-NSSAI_N was disjoint with the S-NSSAI_M (e.g. as shown in FIG. 2 and related description).
2). An app in the UE 3 requires service on a disjoint network slice, e.g. the ‘available S-NSSAI_N’. The network slice S-NSSAI_N is available in the PLMN (i.e. supported by the PLMN) however, the UE 3 is not registered for it. The UE 3 triggers ‘on demand registration for a disjoint network slice, e.g. available S-NSSAI_N.
3). The UE 3 transmits the Registration Request message (on demand registration feature support indication, Requested NSSAI=S-NSSAI_M, in demand NSSAI=S-NSSAI_N) to the AMF_1 10A. In the Registration Request message to the AMF_1 10A the UE 3 includes ‘on demand registration feature support’ indication to indicate that the UE 3 supports the ‘on demand registration’ feature. The UE 3 also includes the requested available S-NSSAI_N in the ‘In demand NSSAI’ parameter along with the S-NSSAI_M in the Requested NSSAI parameter. The S-NSSAI_N within the ‘In demand NSSAI’ parameter has a priority over the requested S-NSSAI_M within the Requested NSSAI parameter.

Alternatively, the in demand S-NSSAI_N may be provided to the AMF_1 10A with an extra differentiated tag (e.g., information, indication or parameter) within an already existing parameter like the Requested NSSAI or any other existing parameter within the Registration Request message so that the AMF_1 10A can distinguish the in demand S-NSSAI_N from the other network slices and give a preference to the in demand S-NSSAI_N when selecting an AMF 10 for rerouting.
4). The ‘in demand S-NSSAI_N’ is not supported by AMF_1 10A. With the help of the NSSF 17, the AMF_1 10A finds the AMF_2 10B which supporting the ‘in demand S-NSSAI_N’ and re-routes the UE 3 to the AMF_2 10B via the (R)AN node 5.
5). Reroute the Initial UE message to the AMF_2 10B and continue the registration procedure with the AMF_2 10B as per 3GPP TS 23.502 [3].
6). If the UE 3 indicated ‘on demand registration feature support’ in the Registration Request message, the AMF_2 10B includes the S-NSSAI_M in the ‘Available NSSAI’ parameter back to the UE 3 as the S-NSSAI_M is not supported by the AMF_2 10B because the S-NSSAI_M and S-NSSAI_N are disjoint network slices and are not supported by the same AMF_2 10B however, the S-NSSAI_M is available in the PLMN and the UE 3 is subscribed for it. When deciding whether the S-NSSAI_M is an available S-NSSAI, the AMF_2 10B may interact with the UDM/UDR 15, PCF 13 and/or other network nodes to verify whether the S-NSSAI_M is a UE subscribed network slice and the S-NSSAI_M is not restricted by the PCC rules or by operator policy or configuration. The AMF_2 10B may also check with the NSSF 17 whether the S-NSSAI_M is supported by another AMF 10 in the location of the UE 3.
7). The AMF_2 10B sends the Registration Accept (Allowed NSSAI=S-NSSAI_N, Available NSSAI=S-NSSAI_M) message to the UE 3. The AMF_2 10B confirms the registration for the in demand S-NSSAI_N by including the S-NSSAI_N in the Allowed NSSAI parameter and the AMF_2 10B also returns the S-NSSAI_M (which now is an available S-NSSAI) within the Available NSSAI parameter. Alternatively, the available S-NSSAI_M may be provided to the UE 3 with an extra differentiating tag (e.g., information, indication or parameter) within an already existing parameter like the Allowed NSSAI or Rejected NSSAI or any other existing parameter within the Registration Accept message so that the UE 3 can distinguish the S-NSSAI_M from the other network slices.
8). The UE 3 can trigger ‘on demand registration’, PDU session establishment request, or service request to the disjoint available S-NSSAI(s) (e.g. S-NSSAI_M) if service(s) on such S-NSSAI(s) is required by the UE 3 or by the application(s) on the UE 3 or the UE 3 receives a Paging message with an indication that the UE 3 requires to activate service(s) on such S-NSSAI(s).

Alternatively, the UE 3 can also, independently from the network, predict, determine, or generate which network slices qualify as available S-NSSAI(s) by deducting the allowed S-NSSAI(s) from the subscribed S-NSSAI(s) list however, in this case there is higher chance the ‘on demand registration’, PDU session establishment request or service request to be rejected as without the network assistance the UE 3 would not have the full information regarding the network slices availability.

### SUMMARY

Beneficially, the above described aspects include, although they are not limited to, one or more of the following functionalities:
Available NSSAI—a list of one or more S-NSSAI(s) for which the UE is subscribed and which are supported by the PLMN however, they are not supported by the current AMF. The list of available S-NSSAI(s) is provided to the UE during registration procedure (e.g. a new parameter within the Registration Accept message).
In demand NSSAI—a list of one or more available S-NSSAI(s) for which the UE triggers on demand registration. The list of one or more available S-NSSAI(s) may be called the list of in demand S-NSSAI(s). The list of in demand S-NSSAI(s) is provided to the network during registration procedure (e.g. a new parameter within the Registration Request message).
On demand registration feature support indication—A UE that supports ‘on demand registration’ indicates ‘on demand registration feature support’ indication during registration procedure (e.g. within the Registration Request message) so that the network provides back the list of available S-NSSAI(s).

In order to provide these functionalities, the above aspects describe exemplary methods comprising (at least some of) the following steps:
On demand registration (solution 1)—A registration by the UE to one or more available S-NSSAI(s). Now, when the UE requires a service on network slice that it is subscribed but not registered to, the UE can trigger registration on that network slice(s) if it is in the list of available S-NSSAI(s) provided to the UE at the last registration. For this, the UE mimics Location Registration by adding the Requested NSSAI and the list of available S-NSSAI(s) into the RRC message and not including the GUAMI or 5G-S-TMSI or 5G-GUTI in the RRC Connection Setup Complete message in order to force the (R)AN node to perform AMF selection as if the UE changes its location although, the UE stays on the same cell. This way the NG-RAN node can selects an AMF that supports the available S-NSSAI (on which a service is required) as the available S-NSSAI is with priority for the ‘on demand registration’.
On demand registration via re-routing (solution 2)—A registration by the UE to one or more available S-NSSAI(s). Now, when the UE requires a service on network slice that it is subscribed but not registered to, the UE can trigger registration on that network slice(s) if it is in the list of available S-NSSAI(s) provided to the UE at the last registration. For this, the UE includes a new parameter ‘In demand NSSAI’ in the Registration Request message so that the UE is rerouted to a target AMF which supports the network slices(s) within the ‘In demand NSSAI’ parameter which have priority over the network slices within the ‘Requested NSSAI’ parameter.

System Overview

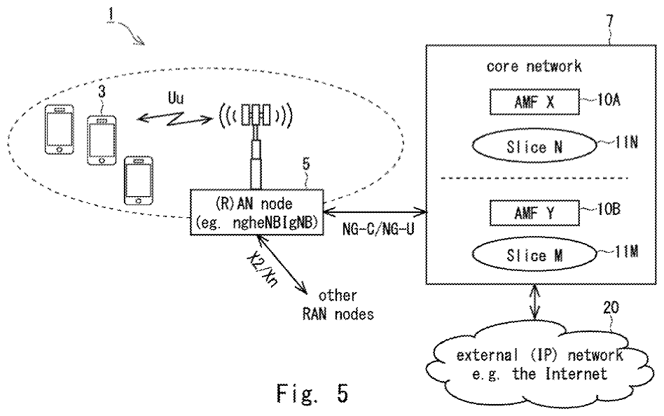

FIG. 5 schematically illustrates a mobile (cellular or wireless) telecommunication system 1 to which the above aspects are applicable.

In this network, users of mobile devices 3 can communicate with each other and other users via respective base stations 5 and a core network 7 using an appropriate 3GPP radio access technology (RAT), for example, an E-UTRA and/or 5G RAT. It will be appreciated that a number of base stations 5 form a (radio) access network or (R)AN. As those skilled in the art will appreciate, whilst three mobile devices 3 and one base station 5 are shown in FIG. 5 for illustration purposes, the system, when implemented, will typically include other base stations and mobile devices. The mobile device(s) 3 may be called UE(s) 3, and the base station(s) 5 may be called (R)AN node(s) 5.

Each base station 5 controls one or more associated cells (either directly or via other nodes such as home base stations, relays, remote radio heads, distributed units, and/or the like). A base station 5 that supports E-UTRA protocols to the mobile devices 3 may be referred to as an ‘ng-eNB’ and a base station 5 that supports Next Generation protocols to the mobile devices 3 may be referred to as a ‘gNB’. It will be appreciated that some base stations 5 may be configured to support both 4G and 5G, and/or any other 3GPP or non-3GPP communication protocols.

A mobile device 3 and its serving base station 5 are connected via an appropriate air interface (for example the so-called ‘Uu’ interface and/or the like). Neighbouring base stations 5 are connected to each other via an appropriate base station to base station interface (such as the so-called ‘X2’ interface, ‘Xn’ interface and/or the like). The base station 5/access network is also connected to the core network nodes via an appropriate interface (such as the so-called ‘NG-U’ interface (for user-plane), the so-called ‘NG-C’ interface (for control-plane), and/or the like).

The core network 7 typically includes logical nodes (or ‘functions’) for supporting communication in the telecommunication system 1. Typically, for example, the core network 7 of a ‘Next Generation’/5G system will include, amongst other functions, control plane functions (CPFs) and user plane functions (UPFs). It will be appreciated that the core network 7 may also include, amongst others: one or more Access and Mobility Management Function (AMF) 10 (e.g. slice specific AMFs 10A/10B), a Policy Control Function (PCF) 13, a Unified Data Management (UDM)/Unified Data Repository (UDR) function 15, and a Network Slice Selection Function (NSSF) 17. Although not shown in FIG. 5, the core network 7 may also be coupled to at least one application function (AF)/application server (AS), and/or the like. From the core network 7, connection to an external IP network/data network 20 (such as the Internet) is also provided.

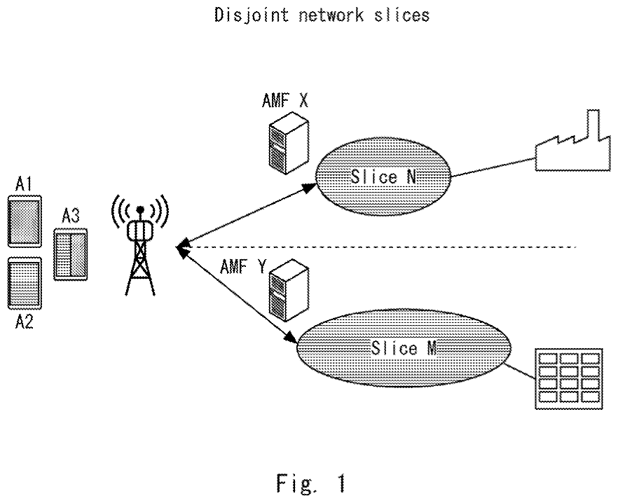

The components of this system 1 are configured to perform one or more of the methods described with reference to FIGS. 1 to 4.

User Equipment (UE)

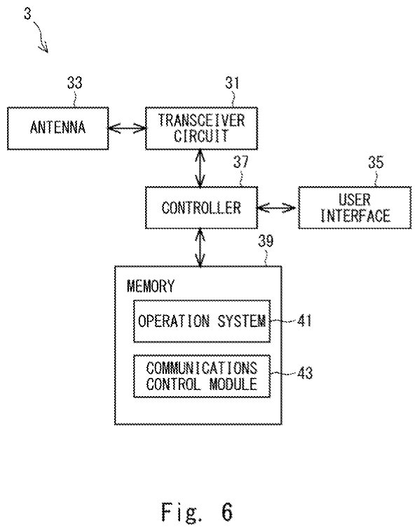

FIG. 6 is a block diagram illustrating the main components of a UE (mobile device 3) shown in FIG. 5. As shown, the UE includes a transceiver circuit 31 which is operable to transmit signals to and to receive signals from the connected node(s) via one or more antenna 33. Although not necessarily shown in FIG. 6, the UE will of course have all the usual functionality of a conventional mobile device (such as a user interface 35) and this may be provided by any one or any combination of hardware, software and firmware, as appropriate. A controller 37 controls the operation of the UE in accordance with software stored in a memory 39. The software may be pre-installed in the memory 39 and/or may be downloaded via the telecommunication network 1 or from a removable data storage device (RMD), for example. The software includes, among other things, an operating system 41 and a communications control module 43. The communications control module 43 is responsible for handling (generating/sending/receiving) signalling messages and uplink/downlink data packets between the UE 3 and other nodes, including (R)AN nodes 5, application functions, and core network nodes. Such signalling includes appropriately formatted requests and responses relating to on demand registration of the UE 3 to disjoint network slices.

(R)AN Node

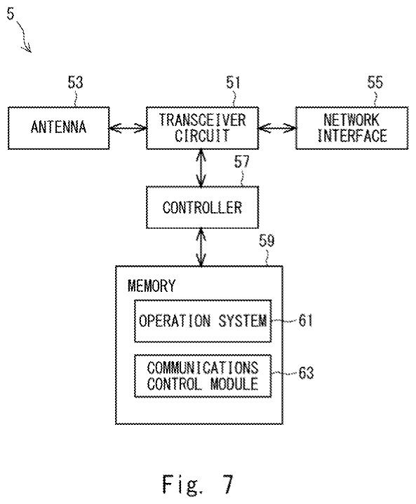

FIG. 7 is a block diagram illustrating the main components of an exemplary (R)AN node 5 (base station) shown in FIG. 5. As shown, the (R)AN node 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as NG-U/NG-C). A controller 57 controls the operation of the (R)AN node 5 in accordance with software stored in a memory 59. The software may be pre-installed in the memory 59 and/or may be downloaded via the telecommunication network 1 or from a removable data storage device (RMD), for example. The software includes, among other things, an operating system 61 and a communications control module 63. The communications control module 63 is responsible for handling (generating/sending/receiving) signalling between the (R)AN node 5 and other nodes, such as the UE 3, and the core network nodes. Such signalling includes appropriately formatted requests and responses relating to on demand registration of a UE 3 to disjoint network slices.

Core Network Node

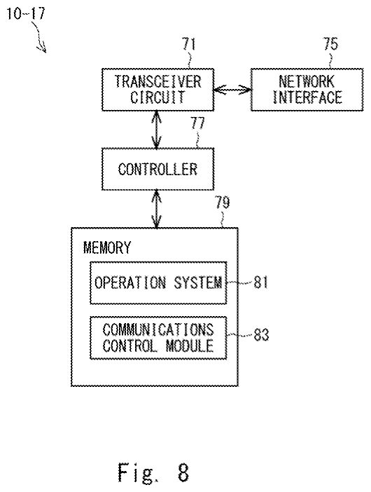

FIG. 8 is a block diagram illustrating the main components of a generic core network node (or function) shown in FIG. 5, for example, the AMF 10, the PCF 13, the UDM/UDR 15, and the NSSF 17. As shown, the core network node includes a transceiver circuit 71 which is operable to transmit signals to and to receive signals from other nodes (including the UE 3 and the (R)AN node 5) via a network interface 75. A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81 and at least a communications control module 83. The communications control module 83 is responsible for handling (generating/sending/receiving) signalling between the core network node and other nodes, such as the UE 3, (R)AN node 5, and other core network nodes. Such signalling includes appropriately formatted requests and responses relating to on demand registration of a UE 3 to disjoint network slices.

Modifications and Alternatives

Detailed aspects have been described above. As those skilled in the art will appreciate, a number of modifications and alternatives can be made to the above aspects whilst still benefiting from the inventions embodied therein. By way of illustration only a number of these alternatives and modifications will now be described.

In the above description, specific messages and parameters are used for illustration purposes. However, it will be appreciated that any other suitable messages and parameters may be used if appropriate. The above described parameters may be included in one or more appropriately formatted information elements and/or the like.

In the above description, the UE, the (R)AN node, and the core network node are described for ease of understanding as having a number of discrete modules (such as the communication control modules). Whilst these modules may be provided in this way for certain applications, for example where an existing system has been modified to implement the above aspects, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (TO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE, the (R)AN node, and the core network node as a signal over a computer network, or on a recording medium. Further, the functionality performed by part or all of this software may be performed using one or more dedicated hardware circuits. However, the use of software modules is preferred as it facilitates the updating of the UE, the (R)AN node, and the core network node in order to update their functionalities.

The above aspects are also applicable to ‘non-mobile’ or generally stationary user equipment.

Various other modifications will be apparent to those skilled in the art and will not be described in further detail here.

The whole or part of the embodiments disclosed above can be described as, but not limited to, the following supplementary notes.

### (Supplementary Note 1)

A communication terminal (3) comprising:
means for sending, to a core network node (10A), a first Non-Access Stratum, NAS, message including first information and second information, the first information indicating that the communication terminal (3) supports on demand registration feature, the second information indicating a list of network slices which the communication terminal (3) requests registration for;
means for receiving, from the core network node (10A), a second NAS message including third information and fourth information, the third information indicating a first network slice which the communication terminal (3) uses in a Public land mobile network, PLMN, the fourth information indicating a second network slice for which the communication terminal (3) is subscribed and which is supported by the PLMN but is not supported by the core network node (10A) that the communication terminal (3) is registered with, the first network slice and the second network slice being included in the list; and
means for triggering on demand registration for the second network slice.

### (Supplementary Note 2)

The communication terminal (3) according to Supplementary note 1, wherein
the means for triggering is performed in a case where the communication terminal (3) or an application in the communication terminal (3) requires a service on the second network slice, or in a case where the communication terminal (3) receives a paging message with an indication that the communication terminal (3) requires to activate the service on the second network slice.

### (Supplementary Note 3)

The communication terminal (3) according to Supplementary note 1 or 2, wherein
the means for triggering is configured to send, to a second core network node (10B), a third NAS message including the first information and the second information.

### (Supplementary Note 4)

The communication terminal (3) according to Supplementary note 1 or 2, wherein
the means for triggering is configured to send, to the core network node (10A), a fourth NAS message including the first information, fifth information and sixth information, the fifth information indicating the first network slice as a network slice which the communication terminal (3) requests registration for, the sixth information indicating the second network slice as a network slice which the communication terminal (3) did not register previously.

### (Supplementary Note 5)

The communication terminal (3) according to any one of Supplementary notes 1 to 4, wherein
the means for receiving is configured to receive, from the second core network node (10B), a fifth NAS message including seventh information and eighth information, the seventh information indicating the second network slice which the communication terminal (3) uses in the PLMN, the eighth information indicating the first network slice for which the communication terminal (3) is subscribed and which is supported by the PLMN but is not supported by the second core network node (10B) that the communication terminal (3) is registered with.

### (Supplementary Note 6)

The communication terminal (3) according to any one of Supplementary notes 1 to 5, wherein
the fourth information is configured per access type, PLMN or registration area.

### (Supplementary Note 7)

A core network node (10A) comprising:
means for receiving, from a communication terminal (3), a first Non-Access Stratum, NAS, message including first information and second information, the first information indicating that the communication terminal (3) supports on demand registration feature, the second information indicating a list of network slices which the communication terminal (3) requests registration for;
means for generating fourth information in a case where the first NAS message is received, the fourth information indicating a second network slice for which the communication terminal (3) is subscribed and which is supported by a Public land mobile network, PLMN, but is not supported by the core network node (10A) that the communication terminal (3) is registered with; and
means for sending, to the communication terminal (3), a second NAS message including third information and the fourth information, the third information indicating a first network slice which the communication terminal (3) uses in the PLMN, the first network slice and the second network slice being included in the list.
   (Supplementary note 8)

The core network node (10A) according to Supplementary note 7, wherein
the fourth information is generated based on at least one of interaction with a network node (5, 17, 13, 15), operator policy and configuration.

### (Supplementary Note 9)

The core network node (10A) according to Supplementary note 7 or 8, wherein
the means for receiving is further configured to receive, from the communication terminal (3), a fourth NAS message including the first information, fifth information and sixth information, the fifth information indicating the first network slice as a network slice which the communication terminal (3) requests registration for, the sixth information indicating the second network slice as a network slice which the communication terminal (3) did not register previously, and
the core network node (10A) further comprises:
means for finding a second core network node (10B) which supporting the second network slice in a case where the second network slice indicated by the fifth information is not supported by the core network node (10A); and
means for re-routing the communication terminal (3) to the second core network node (10B).

### (Supplementary Note 10)

The core network node (10A) according to Supplementary note 7 or 8, wherein
the second core network node (10B) is found based on interaction with a network node (17).

### (Supplementary Note 11)

A method for a communication terminal (3), the method comprising:
sending, to a core network node (10A), a first Non-Access Stratum, NAS, message including first information and second information, the first information indicating that the communication terminal (3) supports on demand registration feature, the second information indicating a list of network slices which the communication terminal (3) requests registration for;
receiving, from the core network node (10A), a second NAS message including third information and fourth information, the third information indicating a first network slice which the communication terminal (3) uses in a Public land mobile network, PLMN, the fourth information indicating a second network slice for which the communication terminal (3) is subscribed and which is supported by the PLMN but is not supported by the core network node (10A) that the communication terminal (3) is registered with, the first network slice and the second network slice being included in the list; and
triggering on demand registration for the second network slice.

### (Supplementary Note 12)

The method according to Supplementary note 11, wherein
the triggering on demand registration is performed in a case where the communication terminal (3) or an application in the communication terminal (3) requires a service on the second network slice, or in a case where the communication terminal (3) receives a paging message with an indication that the communication terminal (3) requires to activate the service on the second network slice.
   (Supplementary note 13)

The method according to Supplementary note 11 or 12, wherein
the triggering on demand registration is configured to send, to the core network node (10A), a fourth NAS message including the first information, fifth information and sixth information, the fifth information indicating the first network slice as a network slice which the communication terminal (3) requests registration for, the sixth information indicating the second network slice as a network slice which the communication terminal (3) did not register previously.
   (Supplementary note 14)

A method for a core network node (10A), the method comprising:
receiving, from a communication terminal (3), a first Non-Access Stratum, NAS, message including first information and second information, the first information indicating that the communication terminal (3) supports on demand registration feature, the second information indicating a list of network slices which the communication terminal (3) requests registration for;
generating fourth information in a case where the first NAS message is received, the fourth information indicating a second network slice for which the communication terminal (3) is subscribed and which is supported by a Public land mobile network, PLMN, but is not supported by the core network node (10A) that the communication terminal (3) is registered with; and
sending, to the communication terminal (3), a second NAS message including third information and the fourth information, the third information indicating a first network slice which the communication terminal (3) uses in the PLMN, the first network slice and the second network slice being included in the list.
   (Supplementary note 15)

The method according to Supplementary note 14, wherein
the fourth information is generated based on at least one of interaction with a network node (5, 17, 13, 15), operator policy and configuration.

This application is based upon and claims the benefit of priority from Indian patent application No. 202011057170, filed on Dec. 30, 2020, the disclosure of which is incorporated herein in its entirety by reference.

### REFERENCE SIGNS LIST

1 telecommunication system
20 IP network/data network
3 UE
31 transceiver circuit
33 antenna
35 user interface
37 controller
39 memory
41 operating system
43 communications control module
5 (R)AN node (base station)
7 core network
51 transceiver circuit
53 antenna
55 network interface
57 controller
59 memory
61 operating system
63 communications control module
10 AMF
13 PCF
15 UDM/UDR
17 NSSF
71 transceiver circuit
75 network interface
77 controller
79 memory
81 operating system
83 communications control module

What is claimed is:

1-15. (canceled)

16. A communication terminal comprising:
at least one memory storing instructions, and
at least one processor configured to execute the instructions to;
receive from a core network node, a first Non-Access Stratum,
NAS, message including first information that indicates a S-NSSAI in a list of configured NSSAI is a subject for an on-demand registration;
when an application in the communication terminal requests to use a service using the S-NSSAI, send to the core network node, a second Non-Access Stratum, NAS, message including the S-NSSAI set to Requested NSSAI, and:
initiate PDU session establishment procedure with the S-NSSAI.

17. The communication terminal according to claim 16,
wherein the PDU session establishment procedure is initiated after a registration procedure of the S-NSSAI is successfully completed.

18. The communication terminal according to claim 16,
wherein the second NAS message includes a second information indicating that the communication terminal supports on demand registration feature.

19. A core network node comprising:
at least one memory storing instructions, and
at least one processor configured to execute the instructions to;
transmit to a communication terminal, a first Non-Access Stratum, NAS, message including first information that indicates a S-NSSAI in a list of configured NSSAI is an on-demand S-NSSAI;
when an application in the communication terminal requests to use a service using the S-NSSAI, receive from the communication terminal, a second Non-Access Stratum, NAS, message including the S-NSSAI set to Requested NSSAI, and:
perform a PDU session establishment procedure with the S-NSSAI when the core network node receives the PDU session establishment request message from the communication terminal.

20. The core network node according to claim 19,
wherein the PDU session establishment procedure is initiated after a registration procedure of the S-NSSAI is successfully completed.

21. The core network node according to claim 19,
wherein the second NAS message includes a second information indicating that the communication terminal supports on demand registration feature.

22. The core network node according to claim 19,
the at least one processor configured to decide the first information based on a subscriber data in a UDM.

23. A method for a communication terminal, the method comprising:
receiving from a core network node, a first Non-Access Stratum, NAS, message including first information that indicates a S-NSSAI in a list of configured NSSAI is a subject for an on-demand registration;
when an application in the communication terminal requests to use a service using the S-NSSAI, sending to the core network node, a second Non-Access Stratum, NAS, message including the S-NSSAI set to Requested NSSAI, and:
initiating PDU session establishment procedure with the S-NSSAI.

24. The method according to claim 23,
wherein the PDU session establishment procedure is initiated after a registration procedure of the S-NSSAI is successfully completed.

25. The method according to claim 24,
wherein the second NAS message includes a second information indicating that the communication terminal supports on demand registration feature.

26. A method for a core network node, the method comprising:
transmitting to a communication terminal, a first Non-Access Stratum, NAS, message including first information that indicates a S-NSSAI in a list of configured NSSAI is an on-demand S-NSSAI;
when an application in the communication terminal requests to use a service using the S-NSSAI, receiving from the communication terminal, a second Non-Access Stratum, NAS, message including the S-NSSAI set to Requested NSSAI, and:
performing a PDU session establishment procedure with the S-NSSAI when the core network node receives the PDU session establishment request message from the communication terminal.

27. The method according to claim 26,
wherein the PDU session establishment procedure is initiated after a registration procedure of the S-NSSAI is successfully completed.

28. The method according to claim 26,
wherein the second NAS message includes a second information indicating that the communication terminal supports on demand registration feature.

29. The method according to claim 26, further comprises deciding the first information based on a subscriber data in a UDM.
